(19) United States
(12) Patent Application Publication
(10) Pub. No.: US 2017/0311585 A1
(43) Pub. Date: Nov. 2, 2017

(54) HEATED SCENT DISPENSER

(71) Applicant: Darryl SHEARER, York, PA (US)

(72) Inventor: Darryl SHEARER, York, PA (US)

(21) Appl. No.: 15/488,651

(22) Filed: Apr. 17, 2017

Related U.S. Application Data
(60) Provisional application No. 62/330,389, filed on May 2, 2016.

(51) Int. Cl. A01M 31/00

(52) U.S. Cl. CPC A01M 31/008

(57) ABSTRACT

A heated scent dispensing device includes an inner housing having an open first end, an upper surface portion having a plurality of apertures, shelf portions adjacent the open first end extending toward each other from opposite sides of the housing and defining a space between their ends for receiving a scent pad thereon, the inner housing supporting a heating pad below the scent pad for allowing heat to reach the scent pad; an outer housing having an open first end and dimensioned to closely receive the inner housing therewithin in telescoping relationship, the outer housing having an upper surface portion having a plurality of apertures which align in registry with the apertures in the upper surface portion of the inner housing when the inner housing is fully received within the outer housing for dispensing scent. Releaseable latching means on the housings retain the inner housing fully within the outer housing.

### FIELD OF THE INVENTION

The present invention relates generally to devices for the release of scents and, more particularly, to devices used for dispensing scents used as an attractant in the hunting of wild game.

### BACKGROUND OF THE INVENTION

It is well known that heat enhances scent distribution. There are many devices available that utilize battery power or household electricity to create heat and/or operate motorized fans for the distribution of scent. However such devices are either expensive to operate or are not reliably portable, particularly in environments where they may be exposed to heat, cold, mud, and the like.

There are many applications which benefit from heating scent or fragrance to aid in its release. These include, but are not limited to odor masking in rooms of homes and offices and in automobiles. Still another application is in the sport of hunting, where hunters regularly use scent to attract their quarry. Various animal pheromones and scent gland, both natural and man made, are marketed for this purpose. Generally, a hunter will establish a protected position or stand to hunt from and will distribute scent around this position to cause the animal to be attracted to the location of the scent. Hunters will, typically, dispense this scent directly into the ground, apply it to their footwear or apply it to a commercially available or custom made “drag” and distribute it thereby in the desired area to draw the animal within close range. However, in recent years, there has been a concern that the use of the natural animal scents may contribute to the spread of disease in the wild, such as Chronic Wasting Disease. Accordingly, there is a need for a device which is portable, effective in dispensing scent and which keeps the scent from coming into direct contact with the ground or vegetation in the field, yet which can be set up and disposed of in a sanitary and safe manner. Such a device would not only benefit hunters, but also would be applicable to the home or office where scent can be dispensed without spraying which, in aerosol form can add dangerous chlorofluorocarbons to the environment and in pump form can potentially stain carpets, clothes and upholstery.

### SUMMARY OF THE INVENTION

In one aspect of the present invention, there is provided a heated scent dispensing device comprising:
an inner housing having an open first end, a closed second end and a substantially hollow body, said inner housing having an upper surface portion defining a top wall of said hollow body and a lower surface portion defining a bottom wall of said hollow body, said upper surface portion comprising a plurality of apertures arranged in a pattern therein, a shelf adjacent said open first end supported from one or both opposite sides of said hollow body intermediate said top wall and said bottom wall and an opening defined in said shelf, said shelf adapted to receive and support a scent pad thereon, said bottom wall below said shelf adapted for supporting a heating pad thereon, said opening in said shelf allowing heat from the heating pad to reach said scent pad;
an outer housing having an open first end, a closed second end and a hollow body, said outer housing having an upper surface portion and a lower surface portion, said upper surface portion comprising a plurality of apertures arranged in a pattern therein, said outer housing being dimensioned to closely receive said inner housing therewithin in telescoping relationship through said open first end while allowing said inner housing to freely slide into and out of said outer housing and to allow said inner housing to be fully received within said outer housing with the open front end of said inner housing adjacent the closed second end of said outer housing;
releaseable latching means on said inner and outer housings to retain said inner housing fully slid within said outer housing; and
said inner housing receiveable within said outer housing between a first position wherein said plurality of apertures in said outer housing are in registry with said plurality of apertures in said inner housing when said inner housing is fully slid within said outer housing to allow the release of scent from the inner housing through said apertures and a second position wherein one of said inner and outer housings are rotated sufficiently that when said inner housing is received within said outer housing said apertures of said inner and outer housings are not in registry, whereby scent is not released from said dispensing device

In another aspect of the invention the inner and outer housings are either both rectangular or both square in cross-section.

In still another aspect of the invention the releaseable latching means comprises at least one raised nub on said inner housing adjacent said open first end and at least one correspondingly located aperture on the outer housing adjacent to said closed second end for engaging said at least one raised nub.

In yet another aspect of the invention said shelf comprises shelf portions extending toward each other from opposite sides of said hollow body and defining a space between said shelf portion ends, said shelf portions adapted to receive and support a scent pad thereon and said space between said shelf portions allowing heat from said heating pad to reach said scent pad.

### BRIEF DESCRIPTION OF THE DRAWINGS

FIG. 1 is an exploded front perspective view of the heated scent dispenser of the present invention illustrating the manner in which the scent and heating elements are inserted therein.

FIG. 2 is an exploded front perspective view of the heated scent dispenser formed by cylindrical housings.

### DETAILED DESCRIPTION OF THE INVENTION

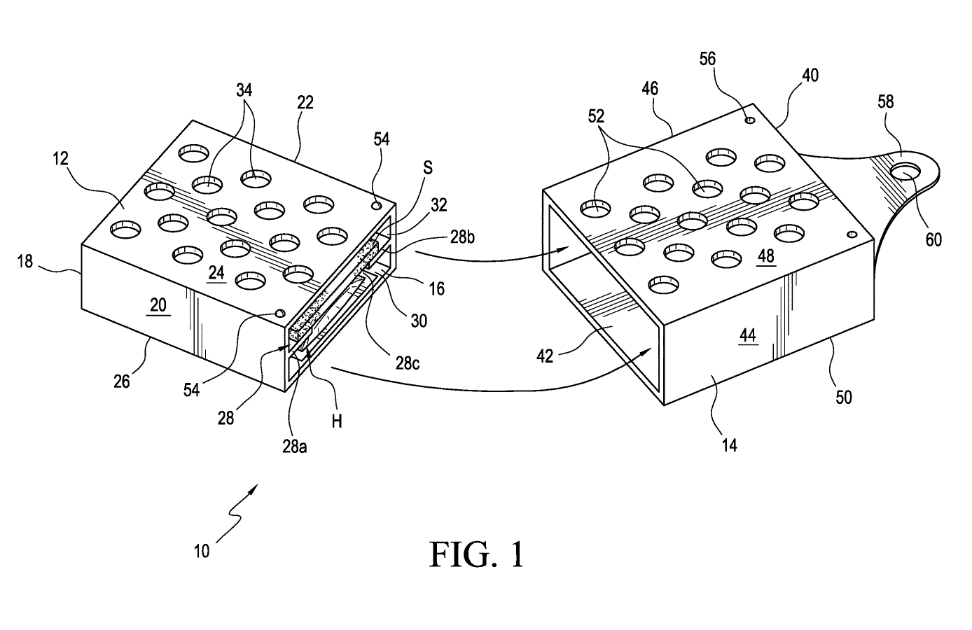

Referring to FIG. 1 there is shown in a preferred embodiment a heated scent dispenser 10 formed of an inner housing 12 and an outer hollow housing 14, the latter being dimensioned to slidably receive the inner housing 12 therein in telescoping relationship. Inner housing 12 and outer housing 14 are desirably formed of a suitable plastic material. If intended for outdoor use, the housings are desirably formed of thermoplastic polymers which can withstand, without damage, the environmental conditions experienced during hunting, such as cold and rain. Inner housing 12 is desirably formed as a rectangular or square box, which is rectangular or square in cross section, having an open front end 16, a rear end 18, opposing left and right sides 20, 22 and opposing upper and lower surfaces 24, 26. A shelf 28 supported by one or both sides 20,22 extends completely or partially across the space between sides 20,22 above lower surface 26 for partitioning inner housing 12 into lower and upper compartments 30, 32 which are enclosed on all sides except at the open front end 16 and at the shelf 28, which may include spaces, apertures or other openings therein. Lower compartment 30 is adapted to receive a heating pad H supported on lower surface 26 while upper compartment 32 is adapted to receive a scent pad S supported on shelf 28. The spaces, apertures or other openings in shelf 28 allow heat from the heating pad H to effectively reach scent pad S. In the preferred embodiment, shelf 28 comprises shelf portions 28a,b extending from left and right sides 20, 22. Inasmuch as scent pads S are available in several different sizes, shelf portions 28a,b each extend a sufficient distance, most desirably about one third of the distance, toward the opposite side 22, 20 to support the scent pad S, leaving a sufficient space 28c between the free ends of the shelf portions 28a,b to allow heat from the heating pad H to effectively reach scent pad S.

Upper surface 24 includes a plurality of apertures 34 therein, arranged in a pattern, to facilitate the release of scent from upper compartment 32. In the preferred embodiment outer housing 14 is also desirably formed as a rectangular or square box and is dimensioned to closely receive inner housing 12 therewithin in such a manner that inner housing 12 can slide into and out of outer housing 14. Outer housing 14 comprises a front end 40, an open rear end 42, opposing left and right sides 44, 46 and opposing upper and lower surfaces 48, 50. As shown in FIG. 1, upper surface 48 includes a plurality of apertures 52, desirably arranged in a corresponding pattern to the apertures 34 of inner housing 12 and, desirably, of the same size as the apertures 34. Apertures 52 are positioned to be in registry with apertures 34 when inner housing 12 is fully slid within outer housing 14 with the open front end 16 of inner housing 12 adjacent the closed front end 40 of outer housing 14. The openings defined by apertures 34, 52 in registry allow air to enter and circulate through to heating pad H, starting the chemical reaction within pad H which creates the heat to heat scent pad S. In a preferred embodiment of the invention, two upstanding features 54, such as hemispherical or other shaped bumps or nubs, are molded on each of the upper and lower surfaces 24, 26 of inner housing 12, desirably close to open front end 16, to align with and engage two correspondingly located apertures 56 in each of the upper and lower surfaces 48, 50 of the outer housing 14, desirably close to front end 40, to retain the inner and outer housings 12, 14 together in a releasable latched relationship when the inner housing 12 is fully slid within outer housing 14. A tab 58 extends outwardly from front end 40 of outer housing 14 and includes an aperture 60 to provide a means of hanging dispenser 10, e.g., from a hook or branch (not shown) and/or attaching tab 58 to a carabiner hook or lanyard (not shown).

The alignment of apertures 34 with apertures 52 facilitates the release of scent from upper compartment 32 of inner housing 12, through apertures 34 and apertures 52 to the ambient. When it is desired that scent is not to be released from dispenser 10, either inner housing 12 or outer housing 14 is rotated to reverse the upper and lower surfaces so that apertures 34, 52 are not in registry whereby scent is not released from the dispenser device 10 and, at the same time, slowing and/or stopping the chemical reaction in heating pad H, which in turn prolongs the life of heating pad H. For example, outer housing 14 may be rotated until upper surface 48, including apertures 52, faces downwardly and lower surface 50 faces upwardly. With this orientation, when inner housing 12 is fully slid within outer housing 14, apertures 34 are blocked by lower surface 50 and scent is not dispensed. It will be appreciated that it is a simple manner to reverse the upper/lower orientation of either of the housings to arrange dispenser 10 for either dispensing scent or not dispensing scent.

Scent pad S is formed of an absorbent material for liquids, such as cotton, felt or a sponge, which may be saturated with the selected liquid animal or other liquid scent which is desired to be dispensed. Heating pad H may be one of the well known heat generating pads, which frequently are used for warming hands or feet. One such heating pad is commercially available under the registered trademark HOT HANDS® from Heatmax, Inc. of Dalton, Ga. A typical heating pad works through a simple chemical reaction that occurs when the heating pad is exposed to air. Frequently, the pad contains a mixture of iron, water, cellulose, vermiculite, activated carbon and salt. When the iron in the pad is exposed to oxygen in the air, it oxidizes and produces heat. The chemical reaction occurs slowly enough to allow the heating pad to last for hours. Eventually, all of the iron is converted to iron oxide and the heat generating reaction stops, at which point it is time to replace the heating pad with another. The heat from heating pad H enhances the intensity of the scent distribution from scent pad S.

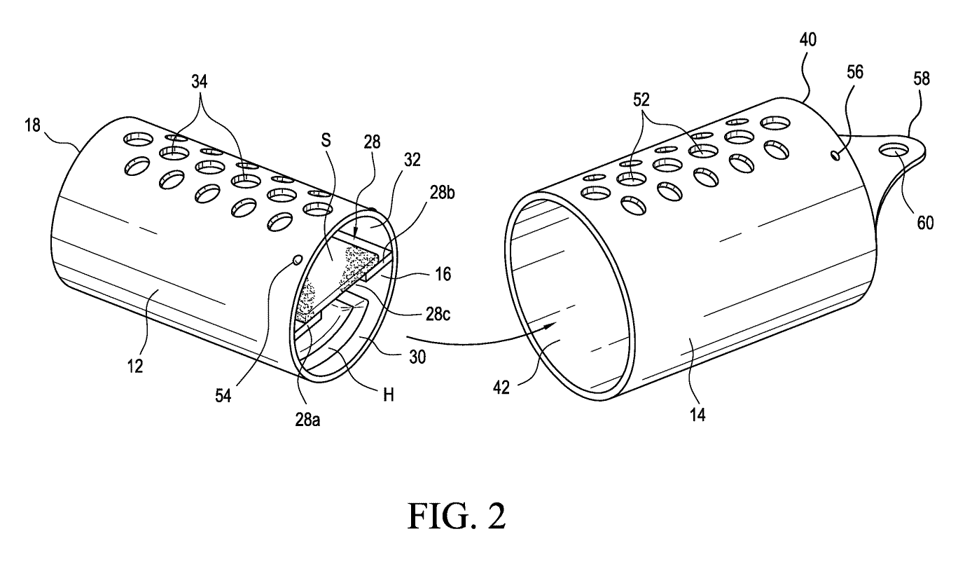

It will be appreciated that the housings 12, 14 need not be rectangular or square as in the preferred embodiment. Rather, they may be any geometrical configuration which allows outer housing 14 to closely receive inner housing 12 in telescoping relationship, permits the inner housing 12 to slide into outer housing 14 to align the plurality of apertures 34, 52 in each housing 12, 14 for activating the heated pad and releasing the scent and to slide into outer housing 14 to position the apertures 34, 52 out of registry for preventing air flow into and out of dispenser 10 and containing the scent. For purposes of illustration, FIG. 2 shows the dispensing device of the present invention with the housings 12,14 in cylindrical configuration, which is circular in cross section. It will be appreciated that housings 12, 14 may be any cross-sectional configuration which meets the criteria of this paragraph. In FIG. 2, identical features bear the same reference numerals as their counterpart features in FIG. 1.

In accordance with the present invention, the dispenser 10 of the present invention may be used indoors, in home or office, by selecting the appropriate and desired scent and placing the housing in the location desired to disperse the scent throughout the selected area of the home or office. When used for hunting, dispenser 10 allows the use of animal scents without contributing to the spread of disease by placing one or more of the dispensers in the areas to which it is desired to lure the game. Inasmuch as the liquid scent is confined to scent pad S, it is always housed within dispenser 10 and, therefore, does not come into contact with the ground or vegetation.

While the present invention has been described in terms of specific embodiments thereof, it will be understood that no limitations are intended to the details of construction or design other than as defined in the appended claims.

1. A heated scent dispensing device comprising:
an inner housing having an open first end, a closed second end and a substantially hollow body, said inner housing having an upper surface portion defining a top wall of said hollow body and a lower surface portion defining a bottom wall of said hollow body, said upper surface portion comprising a plurality of apertures arranged in a pattern therein, a shelf adjacent said open first end supported from one or both opposite sides of said hollow body intermediate said top wall and said bottom wall and an opening defined in said shelf, said shelf adapted to receive and support a scent pad thereon, said bottom wall below said shelf adapted for supporting a heating pad thereon, said opening in said shelf allowing heat from the heating pad to reach said scent pad;
an outer housing having an open first end, a closed second end and a hollow body, said outer housing having an upper surface portion and a lower surface portion, said upper surface portion comprising a plurality of apertures arranged in a pattern therein, said outer housing being dimensioned to closely receive said inner housing therewithin in telescoping relationship through said open first end while allowing said inner housing to freely slide into and out of said outer housing and to allow said inner housing to be fully received within said outer housing with the open front end of said inner housing adjacent the closed second end of said outer housing;
releaseable latching means on said inner and outer housings to retain said inner housing fully slid within said outer housing; and
said inner housing receiveable within said outer housing between a first position wherein said plurality of apertures in said outer housing are in registry with said plurality of apertures in said inner housing to allow the release of scent from the inner housing through said apertures and a second position wherein said apertures of said inner and outer housings are not in registry, whereby scent is not released from said dispensing device.

2. A heated scent dispenser, as claimed in claim 1, wherein in said second position one of said inner and outer housings are rotated sufficiently that said apertures in said housings are out of registry.

3. A heated scent dispenser, as claimed in claim 1, wherein said apertures are in registry when said inner housing is fully slid within said outer housing.

4. A heated scent dispenser, as claimed in claim 1, wherein said shelf comprises shelf portions extending toward each other from opposite sides of said hollow body and defining a space between said shelf portion ends, said shelf portions adapted to receive and support a scent pad thereon and said space between said shelf portions allowing heat from said heating pad to reach said scent pad.

5. A heated scent dispenser, as claimed in claim 1, wherein said inner and outer housings are either both rectangular or both square in cross-section.

6. A heated scent dispenser, as claimed in claim 1, wherein said inner and outer housings are both circular in cross-section.

7. A heated scent dispenser, as claimed in claim 1, wherein said releaseable latching means comprises at least one raised nub on said inner housing adjacent said open first end and at least one correspondingly located aperture on the outer housing adjacent to said closed second end for engaging said at least one raised nub.

8. A heated scent dispenser, as claimed in claim 7, wherein said releaseable latching means comprises two raised nubs on each of the upper and lower surfaces of said inner housing adjacent said open first end and two correspondingly located apertures on each of the upper and lower surfaces of said outer housing adjacent to said closed second end for engaging said nubs.

9. A heated scent dispenser, as claimed in claim 1, wherein each of said shelf portions extend about one third of the distance toward the opposite side of said hollow body.

10. A heated scent dispenser, as claimed in claim 1, wherein said inner and outer housings are formed of a polymeric material.

11. A hollow scent dispenser, as claimed in claim 1, further including a tab having an aperture therein extending from said closed second end for hanging said dispenser from a hook or fixed object.
